(19) United States
(12) Patent Application Publication
(10) Pub. No.: US 2017/0025678 A1
(43) Pub. Date: Jan. 26, 2017

(54) LAYERED OXIDE MATERIALS FOR BATTERIES

(71) Applicant: Sharp Kabushiki Kaisha, Osaka (JP)

(72) Inventors: Robert Gruar, Swindon (GB); Emma Kendrick, North Warnborough (GB)

(21) Appl. No.: 14/804,603

(22) Filed: Jul. 21, 2015

(51) Int. Cl. H01M 4/505; H01M 4/525; H01M 10/054

(52) U.S. Cl. CPC H01M 4/505; H01M 10/054; H01M 4/525; H01M 2004/028

(57) ABSTRACT

A layered oxide material having a composition represented by Chemical Formula (1):

A_{w}M^{j}ₓMⁱ_{y}O₂ (1)

wherein A is sodium or is a mixed alkali metal including sodium as a major constituent; w>0; M^{j} is a transition metal not including Ni or is a mixture of transition metals not including Ni; x>0; j≧1; Mⁱ includes either one or more alkali metals, one or more alkaline earth metals, or a mixture of one or more alkali metals and one or more alkaline earth metals; y>0; i≧1; and Σ(M^{j}+Mⁱ)≧3. A method of forming the layered oxide material includes the steps of mixing one or more precursors in a solvent to form a mixture; heating the mixture to form a reaction product; and cooling the reaction product under air or inert atmosphere.

### TECHNICAL FIELD

The present disclosure relates to electrodes that contain an active material including a layered oxide material, and to the use of such electrodes, for example, in a sodium-ion battery. The present disclosure also relates to the use of these materials, for example, as an electrode material in a rechargeable sodium-ion battery.

### BACKGROUND ART

Lithium-ion battery technology has been the focus of much secondary (rechargeable) battery development and is conventionally the preferred portable battery for most electronic devices. However, several limitations to the broad application of lithium-ion batteries are emerging, such as the cost of lithium prohibiting the use of lithium-ion technology in large scale applications.

By contrast, sodium-ion battery technology is still in its early stages of development but is seen as an advantageous alternative. As sodium is much more abundant than lithium, some researchers predict this will provide a cheaper and more sustainable method to store energy in the future, particularly for large scale applications such as storing energy on the electrical grid or providing stored energy for remote locations.

Sodium-ion batteries are analogous in many ways to the lithium-ion batteries that are in use today. For example, sodium-ion batteries are reusable secondary batteries that include an anode (negative electrode), a cathode (positive electrode) and an electrolyte material. Sodium-ion batteries are capable of storing energy, and they charge and discharge via a similar reaction mechanism to lithium-ion batteries. When a metal-ion secondary battery (lithium- or sodium-ion battery) is charging, (Na⁺ or Li⁺) ions de-intercalate from the cathode and insert into the anode; and charge balancing electrons pass from the cathode through an external circuit and into the anode of the battery. During discharge the same process occurs but in the opposite direction.

There are a number of material types which have been shown to be useful in rechargeable sodium-ion batteries. These include: metallate materials, layered oxide materials, polyanionic compounds, phosphates, and silicates. However, one of the most attractive classes of these materials is that of the layered oxide materials.

As an example of layered oxide materials, sodium layered oxides of the rationalized formula ABO2 can exist as several structural polymorphs, where layers of edge sharing octahedrally coordinated B cations (BO6) are stacked perpendicular to layers of prismatic or octahedrally coordinated A cations. A is generally an alkali metal atom and B is generally a transition metal atom. These materials can be classified into two major groups: P2 type and O3 type, according to Delmas' notation. The O or P designation refers to the local structure around Na⁺ as either an octahedral or prismatic oxygen co-ordination, while the numerical designations refer to the repeat period of the transition metal stacking perpendicular to Na layers. Further, the co-ordination of the A cation can also be described as a ‘partial co-ordination’. This has the notation of P′ in a partial prismatic co-ordination and O′ in a partial octahedral co-ordination.

NaFeO₂ is an example of a sodium-ion layered oxide material which adopts an O3 layered structure. In this material, Fe is mostly present in a +3 oxidation state, Fe³⁺. The Na and Fe atoms are ordered and reside in discrete layers within the structure. In this material, the Na atoms adopt an octahedral co-ordination with oxygen and reside in a discrete layer in the material, the Fe atoms are also octahedrally coordinated and present in another discrete layer perpendicular to the Na layer. The Fe (present as Fe³⁺) is a redox element that contributes to the reversible specific capacity.

Further to NaFeO₂, layered NaFe_{0.5}Mn_{0.5}O₂ is an example of a layered oxide material that shows the same crystal structure as NaFeO₂. In this material both Fe³⁺ and Mn³⁺ are redox active and both contribute to the reversible specific capacity of the material.

A number of publications detail the preparation and electrochemical performance of NaFeO₂ and NaFe_{0.5}Mn_{0.5}O₂. For example, recent electrochemical studies reviewed by Yabuuchi et al. (“Recent research progress on iron- and manganese-based positive electrode materials for rechargeable sodium batteries”, Science and Technology of Advance Materials, 2014) describe the performance of layered NaFe_{0.5} Mn_{0.5}O₂ electrodes in propylene carbonate electrolyte solutions when tested in sodium metal cells. The results obtained in Yabuuchi et al. show that NaFe_{0.5}Mn_{0.5}O₂ exhibits some reversible charging and discharging ability. However, the capacity of the material described in Yabuuchi et al. fades by >30% or more after only 25 cycles, which makes the use of this material extremely disadvantageous for rechargeable energy storage applications.

Most of the background literature for layered oxide materials is based upon stoichiometric sodium transition metal oxides that adopt either a P2 or O3 layered structure as discussed above. Within this material class there are references that discuss material composition, focused on the sodium content and ratios of transition metal elements.

U.S. Pat. No. 5,503,930 (Maruyama et al., issued Apr. 2, 1996) discloses a crystalline layered oxide structure of the general formula: AMO₂ wherein A is Li or Na and M is Co, Ni, Fe or Cr. At least one additive element Z which may be chosen from Bi, Pb or B is present in the form of an oxide on the surface of crystallites or between crystallites.

Japanese Patent Application Publication No. 11059321 (Kishi, published Mar. 2, 1999) discloses a composite metal oxide represented by formula Na(FeₓNi_{y}Mn_{1-x-y})O₂ (wherein x represents a numeral value of 0.1 to 0.6 inclusive; and y represents a numeral value of 0 to 0.9 exclusive). The positive electrode active material comprises the composite metal oxide.

U.S. Pat. No. 7,695,868 (Inoue et al., issued Apr. 13, 2010) discloses a sodium-containing transition metal oxide of the formula (NaₐLi_{b}MₓO_{2±α}) where M includes at least two of Mn, Fe, Co, and Ni. For a negative electrode, a sodium metal or a metal that forms an alloy with sodium is used.

U.S. Patent Application Publication No. 2010/0248001 (Kuze et al., published Sep. 30, 2010) discloses a mixed metal oxide which is useful as a positive electrode active material for secondary batteries. Specifically disclosed is a mixed metal oxide having an a-NaFeO₂ type (layered rocksalt-type) crystal structure and represented by the following formula: NaₓFe_{1-y}M_{y}O₂ (wherein M represents one or more elements selected from the group consisting of group 4 elements, group 5 elements, group 6 elements and group 14 elements of the IUPAC periodic table and Mn; x represents a value more than 0.5 but less than 1; and y represents a value more than 0 but less than 0.5).

Further to these specific documents, U.S. Patent Application Publication No. 2009/0159838 (Okada et al., published Jun. 25, 2009), U.S. Patent Application Publication No. 2011/0003192 (Kuze et al., published Jan. 6, 2011), Japanese Patent Application Publication No. 2009187694 (Makidera et al, published Aug. 20, 2009), and International Patent Application Publication No. WO 2009/099061 (Kuze et al., published Aug. 13, 2009) disclose the application of sodium layered oxide materials for use in energy storage devices.

### SUMMARY OF INVENTION

In accordance with one aspect of the present disclosure, a layered oxide material has a composition represented by Chemical Formula (1):

A_{w}M^{j}ₓMⁱ_{y}O₂ (1)

wherein A is sodium or is a mixed alkali metal including sodium as a major constituent; w>0; M^{j} is a transition metal not including Ni or is a mixture of transition metals not including Ni; x>0; j≧1; Mⁱ includes either one or more alkali metals, one or more alkaline earth metals, or a mixture of one or more alkali metals and one or more alkaline earth metals; y>0; i≧1; and Σ(M^{j}+Mⁱ)≧3.

In some embodiments, Mⁱ further includes one or more metalloids, one or more transition metals not including Fe, Ni, Co, Cr or Mn, one or more non-metals, aluminum, and/or gallium.

In some embodiments, A is sodium.

In some embodiments, A is a mixed alkali metal including sodium as a major constituent.

In some embodiments, M^{j} includes one or more redox active transition metals; and Mⁱ includes one or more non-redox active components.

In some embodiments, M^{j} is Fe; and 0.25≧x≧0.8.

In some embodiments, Mⁱ includes Mg or Na, and one of Mn, Ti, or B; and 0.2≧y≧0.75.

In some embodiments, M^{j} is a mixture of transition metals not including Ni.

In some embodiments, an electrode includes the layered oxide material having the composition represented by Chemical Formula (1).

In some embodiments, an energy storage device includes a cathode, an anode, a separator separating the cathode and the anode, and an electrolyte, wherein the cathode includes the layered oxide material the layered oxide material having the composition represented by Chemical Formula (1).

In some embodiments, the energy storage device is a rechargeable battery.

In accordance with another aspect of the present disclosure, a method is provided of forming a layered oxide material, the layered oxide material having a composition represented by Chemical Formula (1):

A_{w}M^{j}ₓMⁱ_{y}O₂ (1)

wherein A is sodium or is a mixed alkali metal including sodium as a major constituent; w>0; M^{j} is a transition metal not including Ni or is a mixture of transition metals not including Ni; x>0; j≧1; Mⁱ includes either one or more alkali metals, one or more alkaline earth metals, or a mixture of one or more alkali metals and one or more alkaline earth metals; y>0; i≧1; and Σ(M^{j}+Mⁱ)≧3, wherein the method includes: mixing one or more precursors in a solvent to form a mixture; heating the mixture to form a reaction product; and cooling the reaction product under air or inert atmosphere.

In some embodiments, the method further includes pressing the mixture prior to heating.

In some embodiments, the method further includes grinding the cooled reaction product to form a powder.

In some embodiments, the heating is performed at a temperature of between 400° C. and 1500° C. for a time period between 1 hour and 200 hours. In some embodiments, the cooling includes cooling the formed reaction product at a rate of 2° C./min.

In some embodiments, M^{j} is Fe; and 0.25≧x≧0.8.

In some embodiments, Mⁱ includes Mg or Na, and one of Mn, Ti, or B; and 0.2≧y≧0.75.

In some embodiments, M^{j} includes one or more redox active transition metals; and Mⁱ includes one or more non-redox active components.

In some embodiments, Mⁱ further includes one or more metalloids, one or more transition metals not including Fe, Ni, Co, Cr or Mn, one or more non-metals, aluminum, and/or gallium.

The foregoing and other features of the invention are hereinafter described in greater detail with reference to the accompanying drawings.

### BRIEF DESCRIPTION OF DRAWINGS

FIG. 1 shows a flow chart of a representative synthesis method for producing the layered oxide material of the present disclosure.

FIG. 2 shows a powder X-ray diffraction pattern of NaFe_{0.5}Mn_{0.25}Mg_{0.25}O₂ prepared according to Test Example 1.

FIG. 3 shows the cell voltage profile (Voltage [Vs Na/Na⁺] versus cumulative cathode specific capacity [mAh/g]) for the first 3 charge/discharge cycles of NaFe_{0.5}Mn_{0.25}Mg_{0.25}O₂ cycled in a sodium metal cell in accordance with Test Example 1.

FIG. 4 shows the constant current cycle life profile (i.e. the relationship between cathode specific capacity for discharge [mAh/g] and cycle number for a NaFe_{0.5}Mn_{0.25}Mg_{0.25}O₂ cathode) in accordance with Test Example 1.

FIG. 5 shows a powder X-ray diffraction pattern of NaFe_{0.5}Ti_{0.125} Mn_{0.125}Mg_{0.25}O₂ prepared according to Test Example 2.

FIG. 6 shows the cell voltage profile (Voltage [Vs Na/Na⁺] versus cumulative cathode specific capacity [mAh/g]) for the first 3 charge/discharge cycles of NaFe_{0.5}Ti_{0.125}Mn_{0.125}Mg_{0.25}O₂ cycled in a sodium metal cell in accordance with Test Example 2.

FIG. 7 shows a powder X-ray diffraction pattern of NaFe_{0.5}Ti_{0.0625}Mn_{0.1975}Mg_{0.25}O₂ prepared according to Test Example 3.

FIG. 8 shows the cell voltage profile (Voltage [Vs Na/Na⁺] versus cumulative cathode specific capacity [mAh/g]) for the first 3 charge/discharge cycles of NaFe_{0.5}Ti_{0.0625}Mn_{0.1975}Mg_{0.25}O₂ cycled in a sodium metal cell in accordance with Test Example 3.

FIG. 9 shows a powder X-ray diffraction pattern of NaFe_{0.6}Mn_{0.2}Mg_{0.2}O₂ prepared according to Test Example 4.

FIG. 10 shows the cell voltage profile (Voltage [Vs Na/Na⁺] versus cumulative cathode specific capacity [mAh/g]) for the first 3 charge/discharge cycles of NaFe_{0.6}Mn_{0.2} Mg_{0.2}O₂ cycled in a sodium metal cell in accordance with. Test Example 4.

FIG. 11 shows a powder X-ray diffraction pattern of NaFe_{0.7}Mn_{0.15}Mg_{0.15}O₂ prepared according to Test Example 5.

FIG. 12 shows the cell voltage profile (Voltage [Vs Na/Na⁺] versus cumulative cathode specific capacity [mAh/g]) for the first 3 charge/discharge cycles of NaFe_{0.7}Mn_{0.15}Mg_{0.15}O₂ cycled in a sodium metal cell in accordance with Test Example 5.

FIG. 13 shows a powder X-ray diffraction pattern of NaFe_{0.8}Mn_{0.1}Mg_{0.1}O₂ prepared according to Test Example 6.

FIG. 14 shows the cell voltage profile (Voltage [Vs Na/Na⁺] versus cumulative cathode specific capacity [mAh/g]) for the first 3 charge/discharge cycles of NaFe_{0.8}Mn_{0.1}Mg_{0.1}O₂ cycled in a sodium metal cell in accordance with Test Example 6.

FIG. 15 shows a powder X-ray diffraction pattern of NaFe_{1/2}Na_{1/6}Mn_{2/6}O₂ prepared according to Test Example 7 in which Na is doped onto a transition metal site within the crystal structure.

FIG. 16 shows the cell voltage profile (Voltage [Vs Na/Na⁺] versus cumulative cathode specific capacity [mAh/g]) for the first 3 charge/discharge cycles of NaFe_{1/2}Na_{1/6}Mn_{2/6}O₂ cycled in a sodium metal cell in accordance with Test Example 7 in which Na is doped onto a transition metal site within the crystal structure.

FIG. 17 shows a powder X-ray diffraction pattern of Na Fe_{0.3}Mn_{0.25}Mg_{0.25}B_{0.2}O₂ prepared according to Test Example 8.

### DETAILED DESCRIPTION

Hereinafter, the embodiments of the present disclosure will be described with reference to the accompanying tables and figures.

The present disclosure provides a layered oxide material having a composition represented by Chemical Formula (1):

A_{w}M^{j}ₓMⁱ_{y}O₂ (1)

wherein

A is sodium or is a mixed alkali metal including sodium as a major constituent;

w>0;

M^{j} is a transition metal not including Ni or a mixture of transition metals not including Ni;

x>0;

j≧1;

Mⁱ includes either one or more alkali metals, one or more alkaline earth metals, or a mixture of one or more alkali metals and one or more alkaline earth metals;

y>0;

i≧1; and

Σ(M^{j}+Mⁱ)≧3.

In some embodiments, Mⁱ is one or more alkali metals, one or more alkaline earth metals, or a mixture of one or more alkali metals and one or more alkaline earth metals. In other embodiments, Mⁱ further includes one or more metalloids, one or more transition metals not including Fe, Ni, Co, Cr or Mn, one or more non-metals, aluminum, and/or gallium.

In some embodiments, this composition contains 3 or more “M” components (B-site), one of which is a transition metal or mixture of two or more transition metals, excluding Ni. The other components may be any ratio or combination of components as described above. In some embodiments, at least one of the transition metals is a redox active transition metal and one or more of the other components may be non-redox active. In accordance with the present disclosure, substitution of non-redox active components in the layered oxide material may provide an increase in reversible capacity and/or capacity retention when the layered oxide material is used as part of an electrode (e.g., in energy storage devices, rechargeable batteries, electrochemical devices and electrochromic devices). An improvement in material stability may also be observed.

The term “transition metal” as used herein includes the f-block lanthanides and actinides (sometimes referred to as the “inner transition metals”) as well as groups 3 to 12 of the periodic table. The term metalloid refers to non-metals (e.g., P and S) and semi-metals of the groups 13-15 of the periodic table (e.g., B, Si, Ge, As). The term “alkali metal” as used herein includes group 1 elements of the periodic table (i.e., Li, Na, K, Rb, Cs, and Fr), excluding hydrogen. The term “alkaline earth metal” includes group 2 elements of the periodic table (i.e., Be, Mg, Ca, Sr, Ba, and Ra).

Although group 1 and group 2 elements are considered electrochemically inactive (e.g., non-redox active), the addition of these elements to the transition metal layer may have a stabilizing effect on the structure of the active materials used in the electrodes of the present disclosure and may yield higher reversible capacities. Further, the presence of group 1 and group 2 elements may be particularly advantageous to improve the electrochemical stability on cycling; resulting in active materials which are capable of being charged and recharged numerous times with a low reduction in capacity. The active materials including group 1 and group 2 elements may also be advantageous because the addition of these elements may reduce the formula weight of the material and have a positive effect on specific energy density.

In some embodiments, A is a mixed alkali metal including sodium as a major constituent. Exemplary mixed alkali metals including sodium as a major constituent include Na/Li, Na/K, Na/K/Li, Na/Rb, Na/Cs, or combinations thereof.

In some embodiments, M^{j} is a redox active transition metal. Exemplary redox active transition metals include Fe, Mn, Co, and Cr. In other embodiments, M is a mixture of one or more redox active transition metals. Exemplary mixtures include Fe/Mn, Fe/Co, Fe/Cr, Mn/Co, Mn/Cr, and Co/Cr.

In some embodiments, Mⁱ may include one or more non-redox active components. For example, in some embodiments, Mⁱ is an alkali metal. Exemplary alkali metals include Li, Na, K, Rb, Cs, and Fr; preferably Na, Li and K. In other embodiments, Mⁱ is an alkaline earth metal. Exemplary alkaline earth metals include Be, Mg, Ca, Sr, Ba, and Ra. In some embodiments, Mⁱ may include a transition metal. Exemplary transition metals include those defined in groups 3 to 12 of the periodic table, excluding Fe, Mn, Co and Cr. Exemplary transition metals include: Ti, Cu, Zn, and Zr. In some embodiments, Mⁱ may include a metalloid. Exemplary metalloids include: P, S, B, Si, Ge, and As. In some embodiments, Mⁱ is a mixture. Exemplary mixtures include: Mg/Ti, Mg/Zr, Zn/Ti, Zn/Zr, Na/Ti, Na/Li/Ti, Ca/Ti, and Ca/Zr.

In accordance with Chemical Formula (I), the values of w, x and y may be set so as to maintain charge neutrality of the layered oxide material. In some embodiments, the sum of the values of x and y are such that x+y=1. In other embodiments, the sum of the values of w, x and y are such that w+x+y>1. In still other embodiments, the sum of the values of w, x and y are such that w+x+y>1.5. In another embodiment, the sum of the values of w+x+y 2.2. In one example, M^{j} is Fe; and 0.25≧x≧0.8. In another example, Mⁱ includes Mg or Na, and one of Mn, Ti, or B; and 0.2≧y≦0.75.

In some embodiments, for M¹, i=1, 2, 3, 4, or 5. In some embodiments, for M^{j}, j=2, 3, or 4. These oxidation states may or may not be integers, i.e., they may be whole numbers or fractions or a combination of whole numbers and fractions and may be averaged over different crystallographic sites in the material. In some embodiments, the sum of the oxidation states is defined by M^{j}+Mⁱ≧3. In other embodiments, the sum of the oxidation states is defined by 3≦Σ(A+Mⁱ+M^{j})≧4. Such materials may be useful, for example, as electrode materials in rechargeable battery applications.

In some embodiments, the composition may adopt a layered oxide structure in which the alkali metal atoms are coordinated by oxygen in a prismatic environment, or the composition may adopt a layered oxide structure in which the alkali metal atoms are coordinated by oxygen in an octahedral environment. Layers of octahedrally coordinated M cations (MO6) are stacked in between layers of prismatic or octahedrally coordinated A cations. These materials are typically characterised by both the number of B cation layers that constitute the unit cell and the co-ordination of sodium in the A cation layers. These can be described by the Delmas notation, for example (P2, P′3, P3, O2, O′2, O3, O′3), depending upon the stacking of the two layers.

Exemplary compositions of the layered oxide materials of the present disclosure are set forth below in Table 1. For each composition, the components of M^{j} and Mⁱ, including their respective oxidation states [O], are set forth. It will be understood that the list of exemplary compositions set forth in Table 1 are not exhaustive. For example, Table 1 does not include examples of materials in which the oxidation states are not integers or mixture of integers and non-integers.

TABLE 1
Exemplary layered oxide material compositions

| | | M^{j} | | | | Mⁱ | | | | | |
|---|---|---|---|---|---|---|---|---|---|---|---|
| Composition | A | (j = 1) | [O] | (j = 2) | [O] | i = 1 | [O] | i = 2 | [O] | i = 3 | [O] |
| NaFe_{0.5}Mn_{0.25}Mg_{0.25}O₂ | Na | Fe | 3 | Mn | 4 | Mg | 2 | | | | |
| NaFe_{0.9}Mn_{0.05}Mg_{0.05}O₂ | Na | Fe | 3 | Mn | 4 | Mg | 2 | | | | |
| NaFe_{0.7}Mn_{0.15}Mg_{0.15}O₂ | Na | Fe | 3 | Mn | 4 | Mg | 2 | | | | |
| NaFe_{0.5}Ti_{0.25}Mg_{0.25}O₂ | Na | Fe | 3 | | | Ti | 4 | Mg | 2 | | |
| NaFe_{0.8}Ti_{0.1}Mg_{0.1}O₂ | Na | Fe | 3 | | | Ti | 4 | Mg | 2 | | |
| NaFe_{0.95}Ti_{0.025}Mg_{0.025}O₂ | Na | Fe | 3 | | | Ti | 4 | Mg | 2 | | |
| NaFe_{0.5}Ti_{0.125} Mn_{0.125}Mg_{0.25}O₂ | Na | Fe | 3 | Mn | 4 | Ti | 4 | Mg | 2 | | |
| NaFe_{0.5}Ti_{0.125} Zr_{0.125}Mg_{0.25}O₂ | Na | Fe | 3 | Mn | 4 | Zr | 4 | Mg | 2 | | |
| NaFe_{0.5}Mn_{0.25}Ca_{0.25}O₂ | Na | Fe | 3 | Mn | 4 | Ca | 2 | | | | 4 |
| NaFe_{0.95}Mn_{0.025}Ca_{0.025}O₂ | Na | Fe | 3 | Mn | 4 | Ca | 2 | | | | |
| NaFe_{0.5}Ti_{0.25}Ca_{0.25}O₂ | Na | Fe | 3 | | | Ti | 4 | Ca | 2 | | |
| NaFe_{0.95}Ti_{0.025}Ca_{0.025}O₂ | Na | Fe | 3 | | | Ti | 4 | Ca | 2 | | |
| NaFe_{0.5}Ti_{0.125}Mn_{0.125}Ca_{0.25}O₂ | Na | Fe | 3 | Mn | 4 | Ti | 4 | Ca | 2 | | |
| NaFe_{0.4}Ti_{0.2}Mn_{0.2}Zr_{0.2}Ca_{0.25}O₂ | Na | Fe | 3 | Mn | 4 | Zr | 4 | Ti | 4 | Ca | 2 |
| NaMn_{0.5}Zr_{0.25}Mg_{0.25}O₂ | Na | Mn | 3 | | | Zr | 4 | Mg | 2 | | |
| NaMn_{0.95}Zr_{0.025}Mg_{0.025}O₂ | Na | Mn | 3 | | | Zr | 4 | Mg | 2 | | |
| NaMn_{0.5}Ti_{0.25}Mg_{0.25}O₂ | Na | Mn | 3 | | | Ti | 4 | Mg | 2 | | |
| NaMn_{0.5}Ti_{0.25}Ca_{0.25}O₂ | Na | Mn | 3 | | | Ti | 4 | Ca | 2 | | |
| NaMn_{0.5}Ti_{0.125}Mn_{0.125}Mg_{0.25}O₂ | Na | Mn | 3 | Mn | 4 | Ti | 4 | Mg | 2 | | |
| NaMn_{0.5}Ti_{0.125}Mn_{0.0625}Zr_{0.0625}Mg_{0.25}O₂ | Na | Mn | 3 | Mn | 4 | Ti | 4 | Mg | 2 | Zr | 4 |
| NaMn_{0.5}Ti_{0.25}Ca_{0.25}O₂ | Na | Mn | 3 | | | Ti | 4 | Ca | 2 | | |
| NaMn_{0.6}Ti_{0.2}Ca_{0.2}O₂ | Na | Mn | 3 | | | Ti | 4 | Ca | 2 | | |
| NaMn_{0.5}Ti_{0.125-x}Zr_{0.125}Ca_{0.25}O₂ | Na | Mn | 3 | | | Ti | 4 | Ca | 2 | Zr | 4 |
| NaMn_{0.5}Ti_{0.125}Mn_{0.125}Ca_{0.25}O₂ | Na | Mn | 3 | Mn | 4 | Ti | 4 | Ca | 2 | | |
| NaMn_{0.95}Ti_{0.025}Ca_{0.025}O₂ | Na | Mn | 3 | | | Ti | 4 | Ca | 2 | | |
| NaMn_{0.9}Ti_{0.05}Ca_{0.05}O₂ | Na | Mn | 3 | | | Ti | 4 | Ca | 2 | | |
| NaMn_{0.8}Ti_{0.1}Ca_{0.1}O₂ | Na | Mn | 3 | | | Ti | 4 | Ca | 2 | | |
| NaMn_{0.7}Ti_{0.15}Ca_{0.15}O₂ | Na | Mn | 3 | | | Ti | 4 | Ca | 2 | | |
| NaMn_{0.5}Ti_{0.125}Mn_{0.0625}Zr_{0.0625}Ca_{0.25}O₂ | Na | Mn | 3 | Mn | 4 | Ti | 4 | Ca | 2 | Zr | 4 |
| NaCo_{0.5}Ti_{0.25}Ca_{0.25}O₂ | Na | Co | 3 | | | Ti | 4 | Ca | 2 | | |
| NaCo_{0.5}Mn_{0.25}Ca_{0.25}O₂ | Na | Co | 3 | Mn | 4 | | | Ca | 2 | | |
| NaCo_{0.5}Mn_{0.25}Ca_{0.25}O₂ | Na | Co | 3 | Mn | 4 | | | Ca | 2 | | |
| NaCo_{0.95}Ti_{0.025}Ca_{0.025}O₂ | Na | Co | 3 | | | Ti | 4 | Ca | 2 | | |
| NaCo_{0.5}Ti_{0.125}Zr_{0.125}Ca_{0.250}O₂ | Na | Co | 3 | | | Ti | 4 | Ca | 2 | Zr | 4 |
| NaCo_{0.9}Mn_{0.05}Ca_{0.05}O₂ | Na | Co | 3 | Mn | 4 | Ca | 2 | | | | |
| NaCo_{0.5}Ti_{0.125}Mn_{0.125}Ca_{0.25}O₂ | Na | Co | 3 | Mn | 4 | Ca | 2 | Ti | 4 | | |
| NaCo_{0.5}Ti_{0.125}Mn_{0.0625}Zr_{0.0625}Ca_{0.25}O | Na | Co | 3 | Mn | 4 | Ca | 2 | Ti | 4 | Zr | 4 |
| NaCo_{0.95}Mn_{0.025}Ca_{0.025}O₂ | Na | Co | 3 | Mn | 4 | Ca | 2 | | | | |
| NaCo_{0.5}Ti_{0.25}Ca_{0.25}O₂ | Na | Co | 3 | | | Ti | 4 | Ca | 2 | | |
| NaCo_{0.5}Ti_{0.25}Ca_{0.25}O₂ | Na | Co | 3 | | | Ti | 4 | Ca | 2 | | |
| NaCo_{0.6}Ti_{0.2}Ca_{0.2}O₂ | Na | Co | 3 | | | Ti | 4 | Ca | 2 | | |
| NaCo_{0.7}Ti_{0.15}Ca_{0.15}O₂ | Na | Co | 3 | | | Ti | 4 | Ca | 2 | | |
| NaCo_{0.8}Ti_{0.1}Ca_{0.1}O₂ | Na | Co | 3 | | | Ti | 4 | Ca | 2 | | |
| NaCo_{0.95}Mn_{0.025}Mg_{0.025}O₂ | Na | Co | 3 | Mn | 4 | Mg | 2 | | | | |
| NaCo_{0.5}Ti_{0.25}Mg_{0.25}O₂ | Na | Co | 3 | | | Ti | 4 | Mg | 2 | | |
| NaCo_{0.6}Ti_{0.2}Mg_{0.2}O₂ | Na | Co | 3 | | | Ti | 4 | Mg | 2 | | |
| NaCo_{0.7}Ti_{0.15}Mg_{0.15}O₂ | Na | Co | 3 | | | Ti | 4 | Mg | 2 | | |
| NaCo_{0.8}Ti_{0.1}Mg_{0.1}O₂ | Na | Co | 3 | | | Ti | 4 | Mg | 2 | | |
| NaCo_{0.9}Ti_{0.05}Mg_{0.05}O₂ | Na | Co | 3 | | | Ti | 4 | Mg | 2 | | |
| NaCo_{0.95}Ti_{0.025}Mg_{0.025}O₂ | Na | Co | 3 | | | Ti | 4 | Mg | 2 | | |
| NaCo_{0.5}Ti_{0.125}Mn_{0.125}Mg_{0.25}O₂ | Na | Co | 3 | Mn | 4 | Ti | 4 | Mg | 2 | | |
| NaCo_{0.5}Ti_{0.125}Zr_{0.125}Mg_{0.25}O₂ | Na | Co | 3 | | | Ti | 4 | Mg | 2 | Zr | 4 |
| NaCo_{0.5}Ti_{0.125}Mn_{0.0625}Zr_{0.0625}Mg_{0.25}O₂ | Na | Co | 3 | Mn | 4 | Ti | 4 | Mg | 2 | Zr | 4 |
| NaFe_{3/4}Na_{1/12}Ti_{1/18}Mn_{1/18}Zr_{1/18}O₂ | Na | Fe | 3 | Mn | 4 | Ti | 4 | Zr | 4 | Na | 1 |
| NaFe_{1/2}Na_{1/6}Zr_{2/6}O₂ | Na | Fe | 3 | | | Zr | 4 | Na | 1 | | |
| NaFe_{3/4}Na_{1/12}Zr_{1/6}O₂ | Na | Fe | 3 | | | Zr | 4 | Na | 1 | | |
| NaFe_{1/4}Na_{1/4}Ti_{3/12}Mn_{3/12}O₂ | Na | Fe | 3 | Mn | 4 | Ti | 4 | Na | 1 | | |
| NaFe_{1/2}Na_{1/6}Ti_{1/6-x}Mn_{1/6}O₂ | Na | Fe | 3 | Mn | 4 | Ti | 4 | Na | 1 | | |
| NaFe_{3/4}Na_{1/12}Ti_{1/12-x}Mn_{1/12}O₂ | Na | Fe | 3 | Mn | 4 | Ti | 4 | Na | 1 | | |
| NaFe_{1/4}Na_{1/4}Ti_{2/12}Mn_{2/12}Zr_{2/12}O₂ | Na | Fe | 3 | Mn | 4 | Ti | 4 | Na | 1 | Zr | 4 |
| NaFe_{1/2}Na_{1/6}Ti_{1/9}Mn_{1/9}Zr_{1/9}O₂ | Na | Fe | 3 | Mn | 4 | Ti | 4 | Na | 1 | Zr | 4 |
| NaCo_{1/2}Na_{1/6}Zr_{2/6}O₂ | Na | Co | 3 | | | Zr | 4 | Na | 1 | | |
| NaCo_{3/4}Na_{1/12}Ti_{1/18}Mn_{1/18}Zr_{1/18}O₂ | Na | Co | 3 | Mn | 4 | Ti | 4 | Na | 1 | Zr | 4 |
| Na Co_{1/2}Na_{1/6}Ti_{1/9}Mn_{1/9}Zr_{1/9}O₂ | Na | Co | 3 | Mn | 4 | Ti | 4 | Na | 1 | Zr | 4 |
| NaCo_{1/4}Na_{1/4}Ti_{1/6}Mn_{1/6}Zr_{1/6}O₂ | Na | Co | 3 | Mn | 4 | Ti | 4 | Na | 1 | Zr | 4 |
| NaCo_{3/4}Na_{1/12}Ti_{1/12}Mn_{1/12}O₂ | Na | Co | 3 | Mn | 4 | Ti | 4 | Na | 1 | | |
| NaCo_{1/2}Na_{1/6}Ti_{1/6-x}Mn_{1/6}O₂ | Na | Co | 3 | Mn | 4 | Ti | 4 | Na | 1 | | |
| NaCo_{1/4}Na_{1/4}Ti_{1/4}Mn_{1/4}O₂ | Na | Co | 3 | Mn | 4 | Ti | 4 | Na | 1 | | |
| NaCo_{3/4}Na_{1/12}Zr_{1/6}O₂ | Na | Co | 3 | | | Na | 1 | Zr | 4 | | |
| NaFe_{1/2}Na_{1/6}Zr_{2/6}O₂ | Na | Fe | 3 | | | Na | 1 | Zr | 4 | | |
| NaFe_{3/4}Na_{1/12}Zr_{1/6}O₂ | Na | Fe | 3 | | | Na | 1 | Zr | 4 | | |
| NaFe_{1/4}Na_{1/4}Ti_{1/4}Mn_{1/4}O₂ | Na | Fe | 3 | Mn | 4 | Ti | 4 | Na | 1 | | |
| NaFe_{1/2}Na_{1/6}Ti_{1/6}Mn_{1/6}O₂ | Na | Fe | 3 | Mn | 4 | Ti | 4 | Na | 1 | | |
| NaFe_{3/4}Na_{1/12}Ti_{1/12}Mn_{1/12}O₂ | Na | Fe | 3 | Mn | 4 | Ti | 4 | Na | 1 | | |
| NaFe_{1/4}Na_{1/4}Ti_{1/6}Mn_{1/6}Zr_{1/6}O₂ | Na | Fe | 3 | Mn | 4 | Ti | 4 | Na | 1 | Zr | 4 |
| NaFe_{1/2}Na_{1/6}Ti_{1/9}Mn_{1/9}Zr_{1/9}O₂ | Na | Fe | 3 | Mn | 4 | Ti | 4 | Na | 1 | Zr | 4 |
| NaFe_{3/4}Na_{1/12}Ti_{1/18}Mn_{1/18}Zr_{1/18}O₂ | Na | Fe | 3 | Mn | 4 | Ti | 4 | Na | 1 | Zr | 4 |
| NaMn_{3/4}Na_{1/12}Ti_{1/6}O₂ | Na | Mn | 3 | | | Ti | 4 | Na | 1 | | |
| NaMn_{1/2}Na_{1/6}Zr_{2/6}O₂ | Na | Mn | 3 | | | Zr | 4 | Na | 1 | | |
| NaMn_{3/4}Na_{1/12}Zr_{1/6}O₂ | Na | Mn | 3 | | | Zr | 4 | Na | 1 | | |
| NaMn_{3/4}Na_{1/12}Ti_{1/12}Mo_{1/12}O₂ | Na | Mn | 3 | | | Ti | 4 | Na | 1 | Mo | 4 |
| NaMn_{1/4}Na_{1/4}Ti_{1/4}Mo_{1/4}O₂ | Na | Mn | 3 | | | Ti | 4 | Na | 1 | Mo | 4 |
| NaFe_{0.4}Co_{0.1}Ti_{0.25}Mg_{0.25}O₂ | Na | Fe | 3 | Co | 3 | Ti | 4 | Mg | 2 | | |
| NaFe_{0.8}Co_{0.1}Ti_{0.05}Mg_{0.05}O₂ | Na | Fe | 3 | Co | 3 | Ti | 4 | Mg | 2 | | |
| NaFe_{0.9}Co_{0.05}Ti_{0.025}Mg_{0.025}O₂ | Na | Fe | 3 | Co | 3 | Ti | 4 | Mg | 2 | | |
| NaFe_{0.4}Co_{0.1}Ti_{0.125}Mn_{0.125}Mg_{0.25}O₂ | Na | Fe | 3 | Co | 3 | Ti | 4 | Mg | 2 | Mn | 4 |
| NaFe_{0.3}Co_{0.2}Ti_{0.125}Zr_{0.125}Mg_{0.25}O₂ | Na | Fe | 3 | Co | 3 | Ti | 4 | Mg | 2 | Zr | 4 |
| NaFe_{0.5}Ti_{1/12}Mn_{1/12}Zr_{1/12}Mg_{0.25}O₂ | Na | Fe | 3 | Mn | 4 | Ti | 4 | Mg | 2 | Zr | 4 |
| NaFe_{0.8}Ti_{0.1}Ca_{0.1}O₂ | Na | Fe | 3 | | | Ti | 4 | Ca | 2 | | |
| NaFe_{0.9}Ti_{0.05}Ca_{0.05}O₂ | Na | Fe | 3 | | | Ti | 4 | Ca | 2 | | |
| NaFe_{0.95}Ti_{0.0.025}Ca_{0.025}O₂ | Na | Fe | 3 | | | Ti | 4 | Ca | 2 | | |
| NaFe_{0.5}Ti_{0.125}Mn_{0.125}Ca_{0.25}O₂ | Na | Fe | 3 | Mn | 4 | Ti | 4 | Ca | 2 | | |
| NaFe_{0.5}Ti_{0.125}Zr_{0.125}Ca_{0.25}O₂ | Na | Fe | 3 | | | Ti | 4 | Ca | 2 | Zr | 4 |
| NaMn_{0.8}Co_{0.1}Zr_{0.05}Mg_{0.05}O₂ | Na | Mn | 3 | Co | 3 | Zr | 4 | Mg | 2 | | |
| NaMn_{0.9}Co_{0.05}Zr_{0.025}Mg_{0.025}O₂ | Na | Mn | 3 | Co | 3 | Zr | 4 | Mg | 2 | | |
| NaMn_{0.4}Co_{0.1}Ti_{0.25}Mg_{0.25}O₂ | Na | Mn | 3 | Co | 3 | Ti | 4 | Mg | 2 | | |
| NaMn_{0.7}Co_{0.1}Ti_{0.1}Mg_{0.1}O₂ | Na | Mn | 3 | Co | 3 | Zr | 4 | Mg | 2 | | |
| NaMn_{0.8}Co_{0.1}Ti_{0.05}Mg_{0.05}O₂ | Na | Mn | 3 | Co | 3 | Zr | 4 | Mg | 2 | | |
| NaMn_{0.9}Co_{0.05}Ti_{0.025}Mg_{0.025}O₂ | Na | Mn | 3 | Co | 3 | Zr | 4 | Mg | 2 | | |
| NaMn_{0.4}Co_{0.1}Ti_{0.125}Mn_{0.125}Mg_{0.25}O₂ | Na | Mn | 3 | Co | 3 | Zr | 4 | Mg | 2 | Mn | 4 |
| NaMn_{0.4}Co_{0.1}Ti_{0.125}Zr_{0.125}Mg_{0.25}O₂ | Na | Mn | 3 | Co | 3 | Zr | 4 | Mg | 2 | Ti | 4 |
| NaMn_{0.4}Co_{0.1}Ti_{0.25}Ca_{0.25}O₂ | Na | Mn | 3 | Co | 3 | Ti | 4 | Ca | 2 | | |
| NaMn_{0.5}Co_{0.1}Zr_{0.2}Ca_{0.2}O₂ | Na | Mn | 3 | Co | 3 | Zr | 4 | Ca | 2 | | |
| NaMn_{0.6}Co_{0.1}Zr_{0.15}Ca_{0.15}O₂ | Na | Mn | 3 | Co | 3 | Zr | 4 | Ca | 2 | | |
| NaMn_{0.7}Co_{y}Zr_{0.1}Ca_{0.1}O₂ | Na | Mn | 3 | Co | 3 | Zr | 4 | Ca | 2 | | |
| NaMn_{0.5-y}Co_{0.1}Ti_{0.25}Ca_{0.25}O₂ | Na | Mn | 3 | Co | 3 | Ti | 4 | Ca | 2 | | |
| NaMn_{0.9}Co_{0.05}Ti_{0.025}Ca_{0.025}O₂ | Na | Mn | 3 | Co | 3 | Ti | 4 | Ca | 2 | | |
| NaMn_{0.4}Co_{0.1}Ti_{0.125}Mn_{0.125}Ca_{0.25}O₂ | Na | Mn | 3 + 4 | Co | 3 | Ti | 4 | Ca | 2 | | |
| NaMn_{0.3}Co_{0.2}Ti_{0.125}Zr_{0.125}Ca_{0.25}O₂ | Na | Mn | 3 | Co | 3 | Ti | 4 | Ca | 2 | Zr | 4 |

The layered oxide material according to the present disclosure may be embodied as part of an electrode (e.g., a cathode). The layered oxide material may form an active element of the electrode. The electrode may be used in conjunction with a counter electrode and one or more electrolyte materials. The electrolyte material may include an aqueous electrolyte material, or it may include a non-aqueous electrolyte.

In some embodiments, the electrode including the layered oxide material according to the present disclosure may be utilized as part of an energy storage device. The energy storage device may be suitable for use as one or more of the following: A lithium- and/or sodium- and/or potassium-ion cell; a sodium and/or potassium metal cell; a non-aqueous electrolyte sodium- and/or potassium-ion cell; and an aqueous electrolyte sodium- and/or lithium- and/or potassium-ion cell. Examples of energy storage devices include a rechargeable battery, an electrochemical device, and an electrochromic device. Further examples include a sodium ion battery or other electrical energy storage device, including large scale grid level electrical energy storage systems or devices.

In some embodiments, the layered oxide material according to the present disclosure may be embodied as part of an oxide ion conductor.

The materials according to the present disclosure may be prepared using the following representative synthesis method, and sodium metal electrochemical test cells may be prepared using the following representative procedure:

### Representative Synthesis Method:

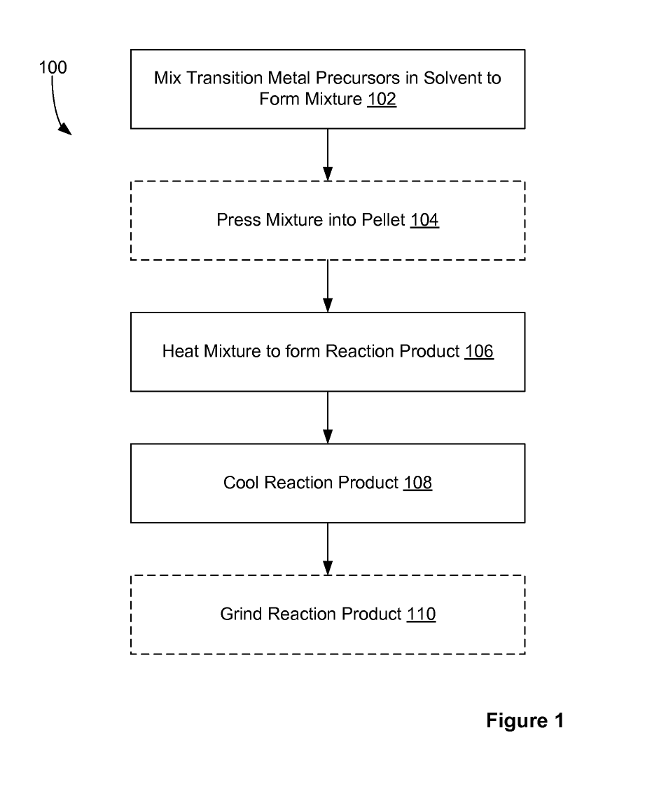

FIG. 1 is a flow chart showing a representative synthesis method 100 for producing the layered oxide material of the present disclosure. In accordance with the representative synthesis method, at step 102, stoichiometric quantities of the precursor materials used to form the target compound are intimately mixed together for a predetermined amount of time. For example, mixing times can range from 10 minutes to 60 hours or until a homogeneous and intimate mixture is obtained. Mixing may be conducted by any suitable mixing method, such as by ball milling. The precursors may also be dispersed in a solvent. Exemplary solvents include water, ethanol, ethylene glycol, methanol, isopropyl alcohol, ether, acetonitrile or hexanol, or mixtures thereof.

Examples of precursor materials include: carbonates of alkali metals, carbonates of alkaline earth metals and carbonates of transition metals. Exemplary alkali metal precursors include: alkali metal or alkaline earth oxides, carbonates, borates, acetates, oxalates, hydroxides, oxyhydroxides, nitrates, sulfates and phosphates, silicates, arsenides and cyanides. Exemplary transition metal precursors include: transition metal oxides, carbonates, acetates, sulfates, nitrates, oxalates, hydroxides, oxyhydroxides, phosphates, silicates, arsenides. Exemplary metalloids (including non metal) precursors include: boric acid, ammonium phosphates, phosphorous oxide, silica, germania, and arsenic salts such as arsenic chloride.

Optionally, at step 104, in some embodiments, the resulting mixture is pressed into a pellet. In other embodiments, step 104 is not performed and the resulting mixture is retained as a free flowing powder.

At step 106, the resulting mixture is heated. In some embodiments, the heating is performed in a tube furnace using either an ambient air atmosphere or a flowing inert atmosphere (e.g., argon or nitrogen). In other embodiments, the heating is performed in a chamber furnace using either an ambient air atmosphere or a flowing inert atmosphere (e.g., argon or nitrogen). The heating may be performed at a furnace temperature of between 400° C. and 1500° C. until the reaction product forms. As an example, Table 2 indicates the heating to be performed for 12 hours. In other examples, the duration of the heating may be longer or shorter depending on the particular reaction product being formed. In some embodiments, the mixed starting materials may be heated for more than 30 seconds and for less than 200 hours. In other embodiments, the mixed starting materials may be heated for more than 30 minutes and for less than 200 hours, preferably between 1 hour and 20 hours. In other embodiments, the mixed starting materials may be heated for between 2 hours and 10 hours.

In some embodiments, a single heating step is used. In other embodiments, more than one heating step is used. For example an initial heating step of between 200° C. and 600° C. for between 30 minutes and 6 hours, followed by a subsequent heating step of between 600° C. and 1200° C. for a time period of between 30 minutes and 24 hours can be used. Optionally, the material may be homogenized by any suitable method between heating steps.

At step 108, the reaction product is cooled. Different cooling protocols can be used to stabilize the formation of the materials. In some embodiments, the material can be removed from the furnace at high temperature and quenched to room temperature. In other embodiments, the material can be slow cooled in the furnace to room temperature, under air or under an inert atmosphere.

Optionally, at step 110, when cool, the reaction product may be removed from the furnace and ground into a powder prior to characterisation and testing.

Using the above representative synthesis method, exemplary active materials were prepared, Examples 1 to 9, as summarised below in Table 2:

TABLE 2
Summary of exemplary O3-type structure layered oxide materials and
synthetic routes. All samples were synthesised in air using a Carbolite ® CWF13
chamber furnace. The samples were heated to the required temperature and
cooled to room temperature under ambient air (25° C.) at a rate of 2° C./min. In
each of the examples, 0.05 Moles of the Target Compound were produced.

| | | STARTING | |
|---|---|---|---|
| | | MATERIALS | |
| | TARGET COMPOUND | (Quantity used | MIXING AND FURNACE |
| Ex. | (ACTIVE MATERIAL) | [g]) | CONDITIONS |
| 1 | NaFe_{0.5}Mn_{0.25}Mg_{0.25}O₂ | Na₂CO₃ [2.649 g] | Ball milled in IPA (iso-propyl- |
| | | Fe₂O₃ [1.996 g] | alcohol) for 1 hr |
| | | MnCO₃ [1.436 g] | Heated to 900° C. for 12 h |
| | | MgCO₃ [1.053 g] | under an ambient |
| | | | atmosphere |
| 2 | NaFe_{0.5}Ti_{0.125}Mn_{0.125}Mg_{0.25}O₂ | Na₂CO₃ [2.649 g] | Ball milled in IPA for 1 hr- |
| | | Fe₂O₃ [1.996 g] | Heated to 900° C. for 12 h |
| | | MnCO₃ [0.718 g] | under an ambient |
| | | MgCO₃ [1.053 g] | atmosphere |
| | | TiO₂ [0.499 g] | |
| 3 | NaFe_{0.5}Ti_{0.0625}Mn_{0.1975}Mg_{0.25}O₂ | Na₂CO₃ [2.649 g] | Ball milled in IPA (iso-propyl- |
| | | Fe₂O₃ [1.996 g] | alcohol) for 1 hr |
| | | MnCO₃ [1.134 g] | Heated to 900° C. for 12 h |
| | | MgCO₃ [1.053 g] | under an ambient |
| | | TiO₂ [0.249 g] | atmosphere |
| 4 | NaFe_{0.6}Mn_{0.2}Mg_{0.2}O₂ | Na₂CO₃ [2.649 g] | Ball milled in IPA (iso-propyl- |
| | | Fe₂O₃ [2.395 g] | alcohol) for 1 hr |
| | | MnCO₃ [1.149 g] | Heated to 900° C. for 12 h |
| | | MgCO₃ [0.843 g] | under an ambient |
| | | | atmosphere |
| 5 | NaFe_{0.7}Mn_{0.15}Mg_{0.15}O₂ | Na₂CO₃ [2.649 g] | Ball milled in IPA (iso-propyl- |
| | | Fe₂O₃ [2.794 g] | alcohol) for 1 hr |
| | | MnCO₃ [0.861 g] | Heated to 900° C. for 12 h |
| | | MgCO₃ [0.632 g] | under an ambient |
| | | | atmosphere |
| 6 | NaFe_{0.8}Mn_{0.1}Mg_{0.1}O₂ | Na₂CO₃ [2.649 g] | Ball milled in IPA (iso-propyl- |
| | | Fe₂O₃ [3.193 g] | alcohol) for 1 hr |
| | | MnCO₃ [0.574 g] | Heated to 900° C. for 12 h |
| | | MgCO₃ [0.421 g] | under an ambient |
| | | | atmosphere |
| 7 | NaFe_{1/2}Na_{1/6}Mn_{2/6}O₂ | Na₂CO₃ [3.091 g] | Ball milled in IPA (iso-propyl- |
| | | Fe₂O₃ [1.9961 g] | alcohol) for 1 hr |
| | | MnCO₃ [1.915 g] | Heated to 900° C. for 12 h |
| | | | under an ambient |
| | | | atmosphere |
| 8 | NaFe_{0.3}Mn_{0.25}Mg_{0.25}B_{0.2}O₂ | Na₂CO₃ [2.649 g] | Ball milled in IPA (iso-propyl- |
| | | Fe₂O₃ [1.197 g] | alcohol) for 1 hr |
| | | MnCO₃ [1.463 g] | Heated to 900° C. for 12 h |
| | | MgCO₃•xH₂O | under an ambient |
| | | [1.136 g] | atmosphere |
| | | B₂O₃ [0.174 g] | |
| 9 | NaFe_{1/2}Mn_{1/4}Mg_{1/4}O₂ | FeC₂O₄•2H₂O | Ball milled in IPA (iso-propyl- |
| | | [3.596 g] | alcohol) for 1 hr |
| | | NaOH [1.999 g] | Heated to 650° C. for 6 h |
| | | MgO [0.503 g] | under an ambient |
| | | MnO₂ [1.086 g] | atmosphere, remilled for 20 |
| | | | minutes |
| | | | heated to 900° C. for 6 hrs |

### Representative Procedure to Make a Sodium Metal Electrochemical Test Cell:

Electrochemical cells were prepared using conventional electrochemical testing techniques. Materials were tested in a Swagelok™ type cell, with a cell stack consisting of a sodium metal anode and active material electrode separated by a glass fibre separator soaked in 0.5M NaClO4 in propylene carbonate (PC) electrolyte solution. The cell stack was inserted into the Swagelok™ fitting and compressed between two stainless steel current collector rods. Materials to be tested were provided as cast electrodes.

To prepare a cast electrode of the test material, the sample was prepared from a slurry using a solvent-casting technique. To test the active materials prepared in Examples 1 to 9 as set forth in Table 2, each slurry contained one of the respective active materials set forth above in Table 2, conductive carbon, binder and solvent. The conductive carbon used in the slurry was Super P C65, manufactured by Timcal. The binder used in the slurry was polyvinylidene fluoride (PVDF) (Kynar HSV7500), manufactured by Arkema. The solvent used in the slurry was N-Methyl-2-pyrrolidone (NMP), Anhydrous, manufactured by Sigma. The slurry was prepared by weighing the active and conductive materials in a container, to which a binder solution was then added. This composite was then homogenised using an IKAT25 (stand homogeniser) for 2 minutes. A Typical slurry mix contained ratios of active material:conductive carbon:binder, 75:18:7 expressed as percentage weight, dispersed in an appropriate quantity of NMP. The slurry was then cast onto an aluminium current collector using the Doctor-blade technique. The formed cast electrode was then dried under Vacuum at about 80-120° C. for about 4 hours. As formed, each electrode film contained the following components, expressed in percent by weight: 75% active material, 18% Super P carbon, and 7% Kynar binder. Optionally, this ratio can be varied (e.g., by adjusting the amounts of the components in the slurry) to optimize the electrode properties such as, adhesion, resistivity and porosity.

The electrolyte was provided as a solution of NaClO₄ in propylene carbonate (PC). In some embodiments, the electrolyte was provided as a 0.5 M solution of NaClO₄ in PC. In other embodiments, the electrolyte was provided as a 1.0 M solution of NaClO₄ in PC. In still other embodiments, the electrolyte can also be any suitable or known electrolyte or mixture thereof. Examples include alternative sodium salts such as NaPF₆ in carbonate based solvents, ionic liquids, polymer electrolytes or solid state electrolytes.

In some embodiments, a glass fiber separator is interposed between the positive and negative electrodes forming the electrochemical test cell. One example of a suitable glass fiber separator is a Whatman grade GF/A separator. In other embodiments, a porous polypropylene or a porous polyethylene separator wetted by the electrolyte is interposed between the positive and negative electrodes forming the electrochemical test cell. One example of a suitable porous polypropylene separator is Celgard 2400. A Whatman grade GF/A glass fiber separator was used in the cell manufacture for electrochemical characterisation of Examples 1-9 described in Table 2.

### Cell Testing:

Electrochemical cells of the exemplary layered oxide materials identified in Table 2 and prepared according to the procedures outlined above were tested using Constant Current Cycling Techniques. The electrochemical cell was cycled at a current density of 5-10 mA/g between pre-set voltage limits as deemed appropriate for the material under test. Appropriate voltage limits are determined experimentally for each sample and are within the electrochemical stability window of the electrolyte. In Examples 1-9, the voltage window stability was shown to be 3.6V-1.5V Vs Na/Na⁺. Other voltage limits may be used, for example 4.3V-2.0V Vs Na/Na⁺. A commercial battery cycler from Maccor Inc. (Tulsa, Okla., USA) was used to collect data. Cells were charged symmetrically between the upper and lower voltage limits at a constant current density. On charge, sodium ions are extracted from the cathode and migrate to the anode. On discharge the reverse process occurs and sodium ions are re-inserted into the cathode material.

### Structural Characterization:

All of the product materials were analyzed by X-ray diffraction techniques using a Bruker D2 Phaser powder diffractometer (fitted with a Lynxeye™ detector) to confirm that the desired target materials had been prepared, to establish the phase purity of the products, and to determine the types of impurities present. From this information it is possible to determine the unit cell lattice parameters.

The operating conditions used to obtain the powder X-ray diffraction patterns illustrated using powdered as made materials, are as follows:

### Range: 2θ=10°-70°

### X-ray Wavelength=1.5418 Å (Angstoms) (Cu Kα)

Step size: 2θ=0.02
Speed: 1.5 seconds/step

### TEST EXAMPLES

The layered oxide materials of the present disclosure will now be exemplified with reference to exemplary materials identified in Table 2, prepared according to the procedures outlined above. As evidenced by the results discussed herein, the material compositions of the present invention have high reversible capacities and good electrochemical stability through the substitution of non-redox active (redox inactive) elements in specific structural sites.

### Test Example 1

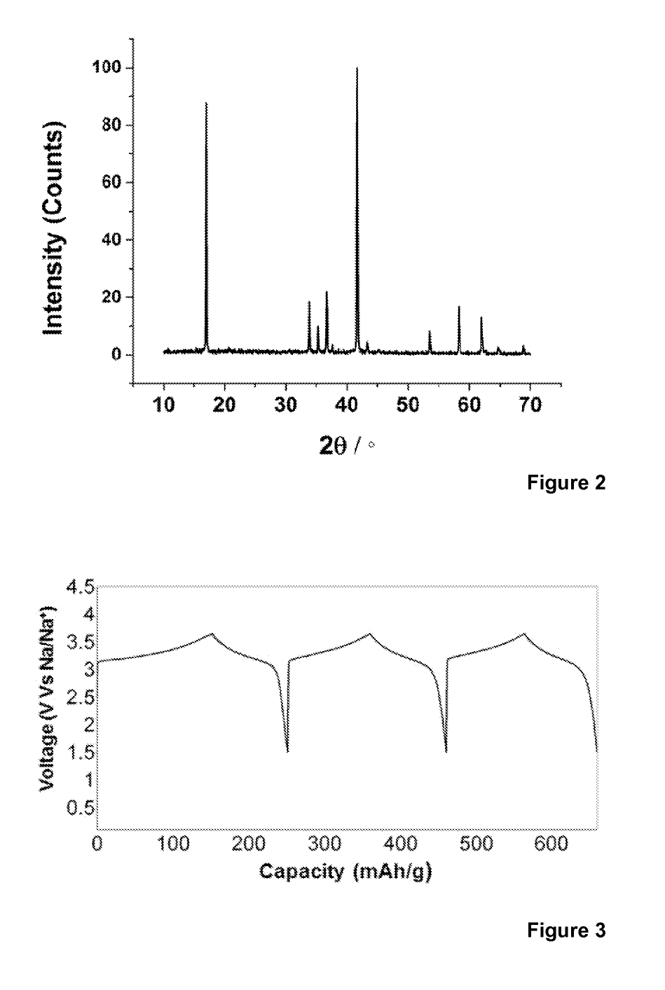

FIG. 2 shows the powder X-ray diffraction pattern of the target compound from Example 1 of Table 2, NaFe_{0.5}Mn_{0.25}Mg_{0.25}O₂ having an O3 layered oxide phase. The as-made target compound of Example 1 was analyzed using the X-ray diffraction technique described above. FIG. 2 shows the intensity (counts) versus the range of 10°-70°2θ.

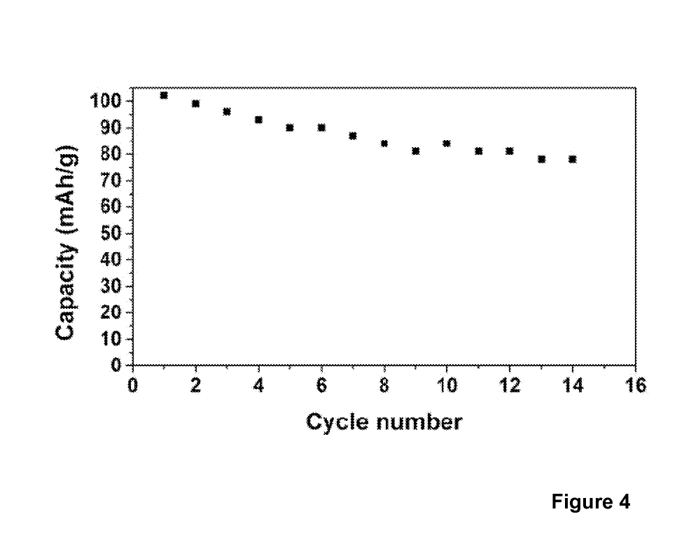

The data shown in FIGS. 3 and 4 are derived from the constant current cycling data for a NaFe_{0.5}Mn_{0.25}Mg_{0.25}O₂ cathode active material in a Na metal half cell where this cathode material was cycled against a thin film of Na metal. The electrolyte used was a 0.5 M solution of NaClO₄ in propylene carbonate (PC). The constant current data was collected at an approximate current of 10 mA/g between voltage limits of 1.50 and 3.65 V Vs Na/Na⁺ and the testing was undertaken at room temperature (i.e., 22° C.). During the cell charging process, sodium ions are extracted from the cathode active material, and plated/deposited onto the Na metal anode. During the subsequent discharge process, sodium ions are stripped from the sodium metal anode and re-intercalate into the cathode active material. FIG. 3 shows the cell voltage profile (Cell Voltage [V] versus Cumulative Cathode Specific Capacity (milliamp hours per gram [mAh/g])) for the first 3 charge/discharge cycles of NaFe_{0.5}Mn_{0.25}Mg_{0.25}O₂ cycled in a sodium metal cell. FIG. 4 shows the constant current cycle life profile (i.e. the relationship between cathode specific capacity for discharge [mAh/g] and cycle number for a NaFe_{0.5}Mn_{0.25}Mg_{0.25}O₂ cathode).

When compared to the known material NaFeO₂ as reviewed by Yabuuchi et al. (Science and Technology of Advance Materials, 2014), substitution of non-redox active elements in the material has led to a significant increase in reversible capacity. A large improvement in material stability is also observed. Typically, NaFeO₂ shows a reversible capacity of 80 mAh/g. In comparison, NaFe_{0.5}Mn_{0.25}Mg_{0.25}O₂ shows a reversible capacity of 97 mAh/g as shown in FIG. 3.

It can be seen that appropriate atomic substitution in these materials yields significant increases in reversible capacity. In FIG. 4 it can also be seen that NaFe_{0.5}Mn_{0.25}Mg_{0.25}O₂ demonstrates reasonable capacity retention over the first few electrochemical cycles. For example, after 14 cycles, the capacity was approximately 80% of the original cathode specific capacity for discharge.

### Test Example 2

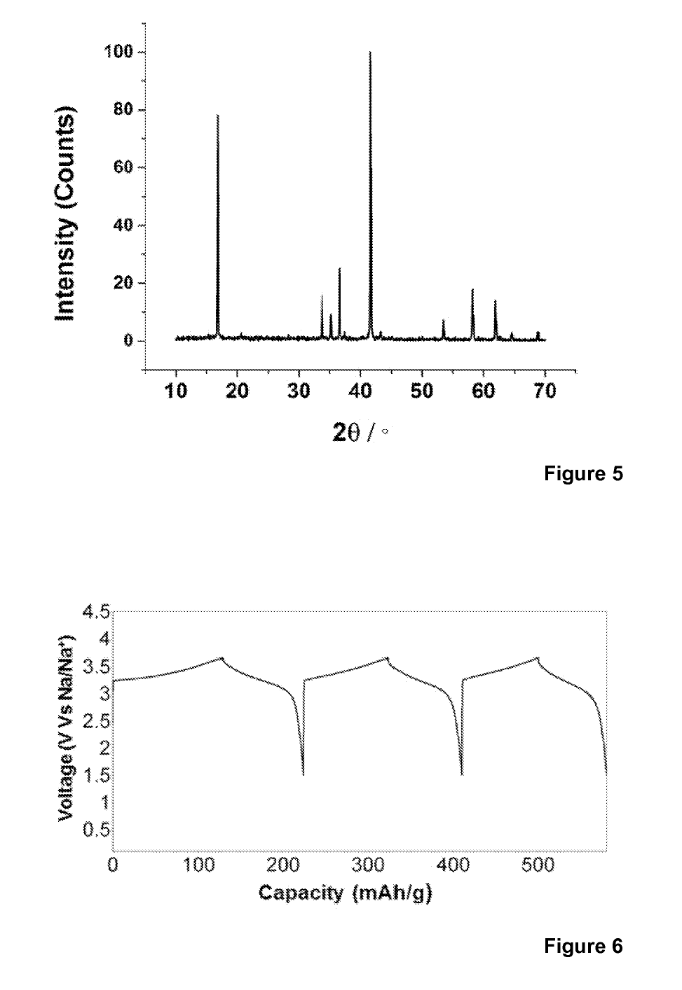

FIG. 5 shows the powder X-ray diffraction pattern of the target compound from Example 2 of Table 2, NaFe_{0.5}Ti_{0.125}Mn_{0.125}Mg_{0.25}O₂ having an O3 layered oxide phase. This material is a compositional variant of Example 1 in which a further element substitution in the transition metal site has yielded an O3 type layered structure. Further atomic substitution within this material was demonstrated as it can significantly influence commercial factors such as cost. FIG. 5 shows the intensity (counts) versus the range of 10°-70°2θ.

The data shown in FIG. 6 is taken from the constant current cycling for NaFe_{0.5}Ti_{0.125} Mn_{0.125}Mg_{0.25}O₂ cathode active material in a Na metal half cell where this cathode material was cycled against a thin film of Na metal. The electrolyte used was a 0.5 M solution of NaClO₄ in propylene carbonate (PC). The constant current data was collected at an approximate current of 10 mA/g between voltage limits of 1.50 and 3.65 V Vs Na/Na⁺ and the testing was undertaken at room temperature (i.e., 22° C.) consistent with the characterisation of Example 1. FIG. 6 shows the cell voltage profile (Cell Voltage [V] versus Cumulative Cathode Specific Capacity (milliamp hours per gram [mAh/g])) for the first 3 charge/discharge cycles of NaFe_{0.5}Ti_{0.125} Mn_{0.125}Mg_{0.25}O₂ cycled in a sodium metal cell.

It can be seen in FIG. 6 that further substitution within the layered oxide framework was not detrimental to the electrochemical performance of the material when compared with Test Example 1. NaFe_{0.5}Ti_{0.125} Mn_{0.125}Mg_{0.25}O₂ showed a reversible capacity of 92 mAh/g. This is comparable to that observed in Test Example 1.

### Test Example 3

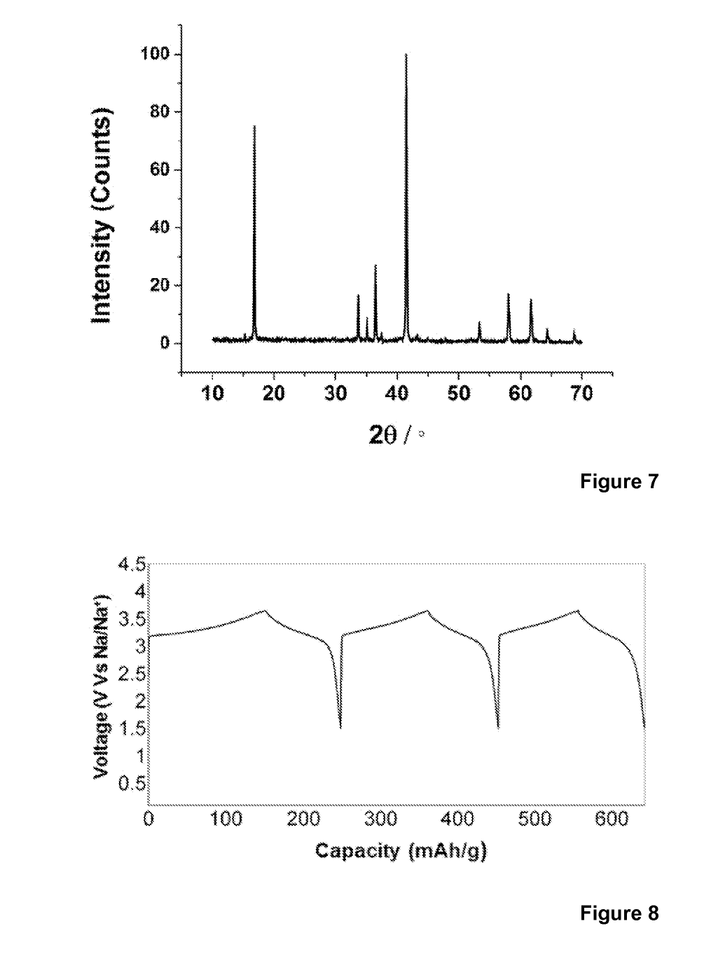

FIG. 7 shows the powder X-ray diffraction pattern of the target compound from Example 3 of Table 2, NaFe_{0.5}Ti_{0.0625}Mn_{0.1975}Mg_{0.25}O₂ having an O3 layered oxide phase. This material is a compositional variant of Example 2 in which the proportion of element substitution in the transition metal site has been varied but yielded the same layered oxide framework. FIG. 7 shows the intensity (counts) versus the range of 10°-70°2θ.

The data shown in FIG. 3(B) is taken from the constant current cycling for NaFe_{0.5}Ti_{0.125}Mn_{0.125}Mg_{0.25}O₂ cathode active material in a Na metal half cell. The constant current data was collected at an approximate current of 10 mA/g between voltage limits of 1.50 and 3.65 V Vs Na/Na⁺ and the testing was undertaken at room temperature (i.e., 22° C.) consistent with the characterization of Test Example 1 and Test Example 2. FIG. 8 shows the cell voltage profile (Cell Voltage [V] versus Cumulative Cathode Specific Capacity (milliamp hours per gram [mAh/g])) for the first 3 charge/discharge cycles of NaFe_{0.5}Ti_{0.125}Mn_{0.125}Mg_{0.25}O₂ cycled in a sodium metal cell.

It can be seen in FIG. 8 that further substitution within the layered oxide frame work was not detrimental to the electrochemical performance of the material when compared with Test Example 2. The cathode material NaFe_{0.5}Ti_{0.125}Mn_{0.125}Mg_{0.25}O₂ shows a reversible capacity of 105 mAh/g.

### Test Example 4

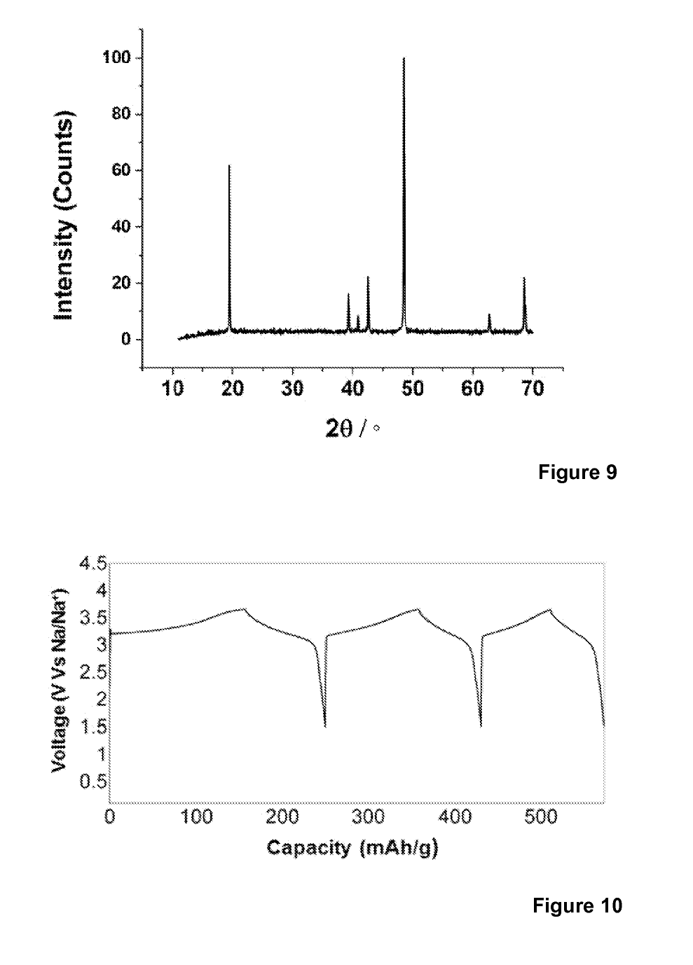

FIG. 9 shows the powder X-ray diffraction pattern of the target compound from Example 4 of Table 2, NaFe_{0.6} Mn_{0.2}Mg_{0.2}O₂ having an O3 layered oxide phase. This material is a compositional variant of Example 1 in which the proportion of element substitution in the transition metal site has been lowered yielding the same layered oxide framework. FIG. 9 shows the intensity (counts) versus the range of 10°-70°2θ.

The data shown in FIG. 10 is taken from the constant current cycling for NaFe_{0.6}Mn_{0.2}Mg_{0.2}O₂ cathode active material in a Na metal half cell. The constant current data was collected at an approximate current of 10 mA/g between voltage limits of 1.50 and 3.65 V Vs Na/Na⁺ and the testing was undertaken at room temperature (i.e., 22° C.) consistent with the characterisation of Test Example 3. FIG. 10 shows the cell voltage profile (Cell Voltage [V] versus Cumulative Cathode Specific Capacity (milliamp hours per gram [mAh/g])) for the first 3 charge/discharge cycles of NaFe_{0.6}Mn_{0.2}M g_{0.2}O₂ cycled in a sodium metal cell.

It can be seen in FIG. 10 that further substitution within the layered oxide frame work was not detrimental to the electrochemical performance of the material when compared with Test Example 3. The cathode material NaFe_{0.6}Mn_{0.2}Mg_{0.2}O₂ exhibits a reversible capacity of 95 mAh/g.

### Test Example 5

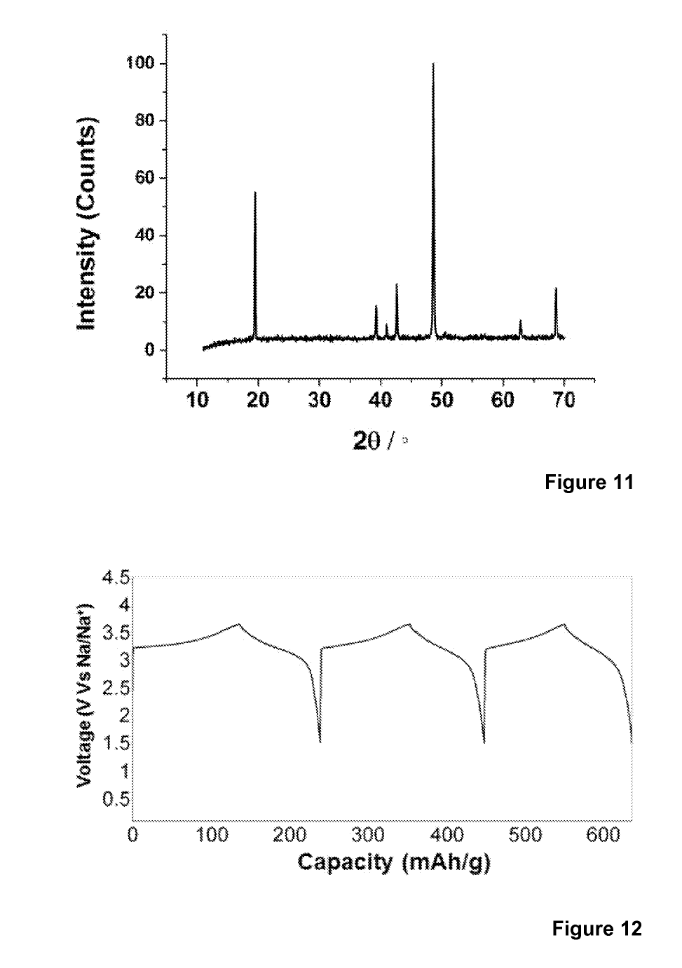

FIG. 11 shows the powder X-ray diffraction pattern of the target compound from Example 5 of Table 2, NaFe_{0.7}Mn_{0.15}Mg_{0.15}O₂ having an O3 layered oxide phase. This material is a compositional variant of Example 4 in which the proportion of element substitution in the transition metal site has been lowered further yielding the same layered oxide framework. FIG. 11 shows the intensity (counts) versus the range of 10°-70°2θ.

The data shown in FIG. 12 is taken from the constant current cycling for NaFe_{0.7}Mn_{0.15}Mg_{0.15}O₂ cathode active material in a Na metal half cell. The constant current data was collected at an approximate current of 10 mA/g between voltage limits of 1.50 and 3.65 V Vs Na/Na⁺ and the testing was undertaken at room temperature (i.e., 22° C.) consistent with the characterisation of Test Example 4. FIG. 12 shows the cell voltage profile (Cell Voltage [V] versus Cumulative Cathode Specific Capacity (milliamp hours per gram [mAh/g])) for the first 3 charge/discharge cycles of NaFe_{0.7}Mn_{0.15}Mg_{0.15}O₂ cycled in a sodium metal cell.

It can be seen in FIG. 12 that further substitution within the layered oxide frame work was not detrimental to the electrochemical performance of the material when compared with Test Example 4. The cathode material NaFe_{0.7}Mn_{0.15}Mg_{0.15}O₂ shows a reversible capacity of 105 mAh/g.

### Test Example 6

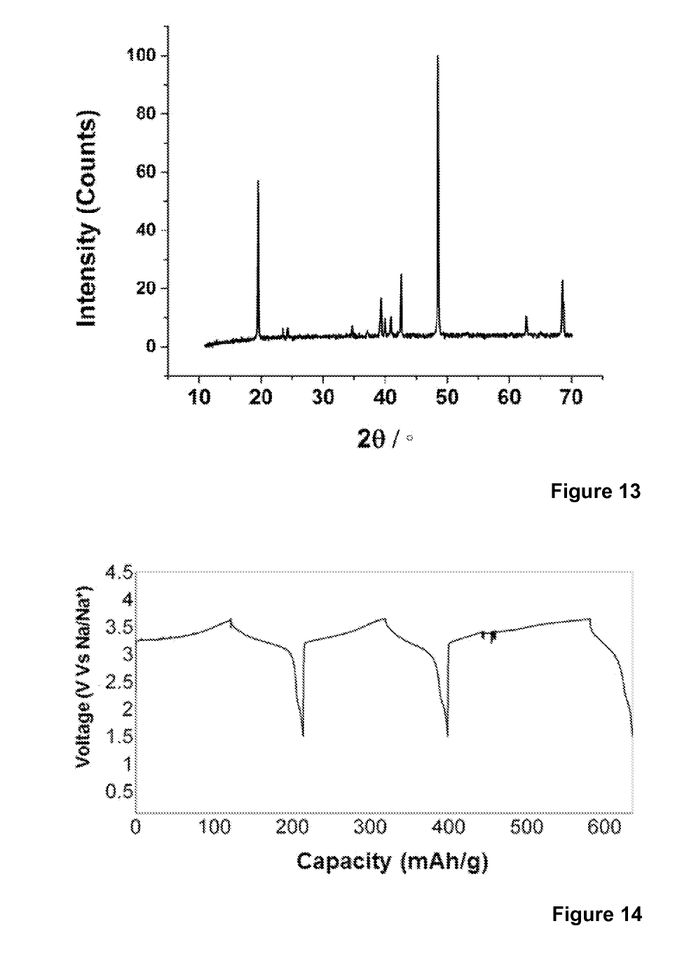

FIG. 13 shows the powder X-ray diffraction pattern of the target compound from Example 6 of Table 2, NaFe_{0.8}Mn_{0.1}Mg_{0.1}O₂ having an O3 layered oxide phase. This material is a compositional variant of Example 5 in which the proportion of element substitution in the transition metal site has been lowered, further again yielding the same layered oxide framework. FIG. 13 shows the intensity (counts) versus the range of 10°-70°2θ.

The data shown in FIG. 14 is taken from the constant current cycling for NaFe_{0.8}Mn_{0.1}Mg_{0.1}O₂ cathode active material in a Na metal half cell. The constant current data was collected at an approximate current of 10 mA/g between voltage limits of 1.50 and 3.65 V Vs Na/Na⁺ and the testing was undertaken at room temperature (i.e., 22° C.) consistent with the characterization of Test Example 5. FIG. 14 shows the cell voltage profile (Cell Voltage [V] versus Cumulative Cathode Specific Capacity (milliamp hours per gram [mAh/g])) for the first 3 charge/discharge cycles of NaFe_{0.8}Mn_{0.1}Mg_{0.1}O₂ cycled in a sodium metal cell.

It can be seen in FIG. 14 that further substitution within the layered oxide frame work was not detrimental to the electrochemical performance of the material when compared with Test Example 4. The cathode material NaFe_{0.8}Mn_{0.1}Mg_{0.1}O₂ shows a reversible capacity of 95 mAh/g

### Test Example 7

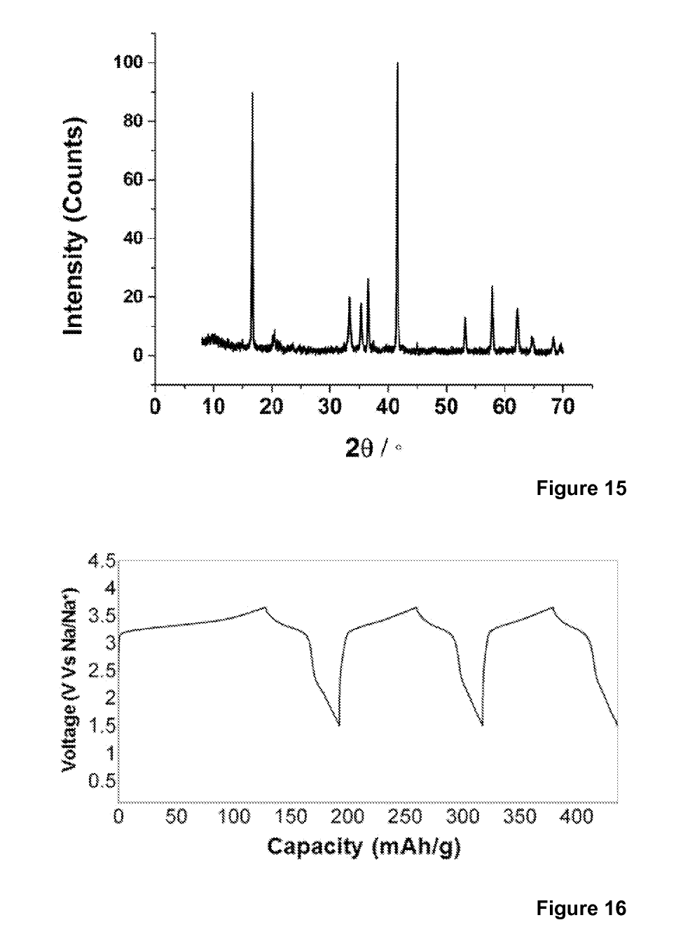

FIG. 15 shows the powder X-ray diffraction pattern of the target compound from Example 7 of Table 2, NaFe_{1/2}Na_{1/6}Mn_{2/6}O₂ having an O3 layered oxide phase. This material is a compositional variant of Example 1 in which Na has been doped into a transition metal site within the layered oxide frame work. FIG. 15 shows the intensity (counts) versus the range of 10°-70°2θ. It is clear from the diffraction pattern shown therein that doping alkali metals onto transition metal sites leads to long range ordering (superstructure) and the appearance of further diffraction lines between 20°-35°2θ. From this data it can be seen that the structure of this material is principally an O3 layered oxide phase.

The data shown in FIG. 16 is taken from the constant current cycling for NaFe_{1/2}Na_{1/6}Mn_{2/6}O₂ cathode active material in a Na metal anode cell. The constant current data was collected at an approximate current of 10 mA/g between voltage limits of 1.50 and 3.65 V Vs Na/Na⁺ and the testing was undertaken at room temperature (i.e., 22° C.) consistent with the characterisation of Test Example 1. FIG. 16 shows the cell voltage profile (Cell Voltage [V] versus Cumulative Cathode Specific Capacity (milliamp hours per gram [mAh/g])) for the first 3 charge/discharge cycles of NaFe_{1/2}Na_{1/6}Mn_{2/6}O₂ cycled in a sodium metal cell.

It can be seen in FIG. 16 that substitution within the layered oxide frame work alters the electrochemical performance of the material when compared to Test Examples 1-6. The Cathode material NaFe_{1/2}Na_{1/6}Mn_{2/6}O₂ reversible capacity of 67 mAh/g This material demonstrated excellent capacity retention when compared to NaFeO₂ but lower capacity. When viewed in conjunction with Test Examples 4-6, the substitution of Na in the transition metal layer reduced the intercalation of sodium in the structure but increases the reversibility.

### Test Example 8

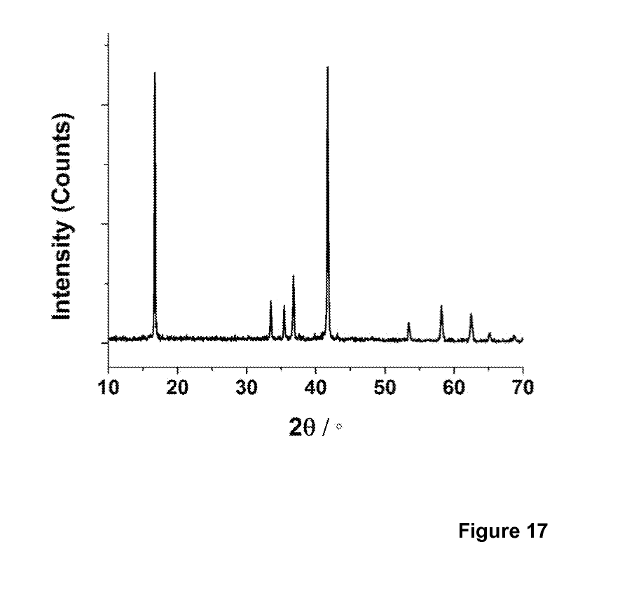

FIG. 17 shows the powder X-ray diffraction pattern of the target compound from Example 8 of Table 2, NaFe_{0.3}Mn_{0.25}Mg_{0.25} B_{0.2}O₂ having an O3 layered oxide phase. This material is a compositional variant of Example 1 in which Boron has been doped into a transition metal site within the layered oxide frame work. FIG. 17 shows the intensity (counts) versus the range of 10°-70° 28. It is clear from the diffraction pattern shown therein that doping metalloids onto transition metal sites may lead to a similar material structure to that reported for the other examples. From this data it can be seen that the structure of this material is principally an O3 layered oxide phase.

Although the invention has been shown and described with respect to a certain embodiment or embodiments, equivalent alterations and modifications may occur to others skilled in the art upon the reading and understanding of this specification and the accompanying drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein exemplary embodiment or embodiments of the invention. In addition, while a particular feature of the invention may have been described above with respect to only one or more of several embodiments, such feature may be combined with one or more other features of the other embodiments, as may be desired and advantageous for any given or particular application.

### INDUSTRIAL APPLICABILITY

Electrodes according to the present invention are suitable for use in many different applications, energy storage devices, rechargeable batteries, electrochemical devices and electrochromic devices. Advantageously, the electrodes according to the invention may be used in conjunction with a counter electrode and one or more electrolyte materials. The electrolyte materials may be any conventional or known materials and may include either aqueous electrolyte or non-aqueous electrolytes or a mixture thereof.

1. A layered oxide material having a composition represented by Chemical Formula (1):
A_{w}M^{j}ₓMⁱ_{y}O₂ (1)
wherein
A is sodium or is a mixed alkali metal including sodium as a major constituent;
w>0;
M^{j} is a transition metal not including Ni or is a mixture of transition metals not including Ni;
x>0;
j≧1;
Mⁱ comprises either one or more alkali metals, one or more alkaline earth metals, or a mixture of one or more alkali metals and one or more alkaline earth metals;
y>0;
i≧1; and
Σ(M^{j}+Mⁱ)≧3.

2. The layered oxide material of claim 1, wherein Mⁱ further comprises one or more metalloids, one or more transition metals not including Fe, Ni, Co, Cr or Mn, one or more non-metals, aluminum, and/or gallium.

3. The layered oxide material of claim 1, wherein A is sodium.

4. The layered oxide material of claim 1, wherein A is a mixed alkali metal including sodium as a major constituent.

5. The layered oxide material of claim 1, wherein:
M^{j} comprises one or more redox active transition metals; and
Mⁱ comprises one or more non-redox active components.

6. The layered oxide material of claim 1, wherein:
M^{j} is Fe; and
0.25≧x≧0.8.

7. The layered oxide material of claim 1, wherein:
Mⁱ comprises Mg or Na, and one of Mn, Ti, or B; and
0.2≧y≧0.75.

8. The layered oxide material of claim 1, wherein M^{j} is a mixture of transition metals not including Ni.

9. An electrode comprising the layered oxide material of claim 1.

10. An energy storage device comprising a cathode, an anode, a separator separating the cathode and the anode, and an electrolyte, wherein the cathode comprises the layered oxide material of claim 1.

11. The energy storage device of claim 10, wherein the energy storage device is a rechargeable battery.

12. A method of forming a layered oxide material, the layered oxide material having a composition represented by Chemical Formula (1):
A_{w}M^{j}ₓMⁱ_{y}O₂ (1)
wherein
A is sodium or is a mixed alkali metal including sodium as a major constituent;
w>0;
M^{j} is a transition metal not including Ni or is a mixture of transition metals not including Ni;
x>0;
j≧1;
Mⁱ comprises either one or more alkali metals, one or more alkaline earth metals, or a mixture of one or more alkali metals and one or more alkaline earth metals;
y>0;
i≧1; and
Σ(M^{j}+Mⁱ)≧3,
wherein the method comprises:
mixing one or more precursors in a solvent to form a mixture;
heating the mixture to form a reaction product; and
cooling the reaction product under air or inert atmosphere.

13. The method of claim 12, further comprising pressing the mixture prior to heating.

14. The method of claim 12, further comprising grinding the cooled reaction product to form a powder.

15. The method of claim 12, wherein the heating is performed at a temperature of between 400° C. and 1500° C. for a time period between 1 hour and 200 hours.

16. The method of claim 12, wherein the cooling comprises cooling the formed reaction product at a rate of 2° C./min.

17. The method of claim 12, wherein:
M^{j} is Fe; and
0.25≧x≧0.8.

18. The method of claim 12, wherein:
Mⁱ comprises Mg or Na, and one of Mn, Ti, or B; and
0.2≧y≧0.75.

19. The method of claim 12, wherein:
M^{j} comprises one or more redox active transition metals; and
Mⁱ comprises one or more non-redox active components.

20. The method of claim 12, wherein Mⁱ further comprises one or more metalloids, one or more transition metals not including Fe, Ni, Co, Cr or Mn, one or more non-metals, aluminum, and/or gallium.
